(19) United States
(12) Patent Application Publication
(10) Pub. No.: US 2006/0123229 A1
(43) Pub. Date: Jun. 8, 2006

(54) Database integration platform for security systems

(76) Inventors: Robert Lance Holloway, Indianapolis, IN (US); John G. Stoller, Fishers, IN (US); Michael Lee Long, Noblesville, IN (US)

Correspondence Address: BAKER & DANIELS LLP, 300 NORTH MERIDIAN STREET, SUITE 2700, INDIANAPOLIS, IN, 46204, US

(21) Appl. No.: 11/186,437

(22) Filed: Jul. 21, 2005

Related U.S. Application Data
(60) Provisional application No. 60/590,455, filed on Jul. 23, 2004.

(51) Int. Cl. H04L 9/00

(52) U.S. Cl. 713/164; 713/166

(57) ABSTRACT

A database integration platform configured to facilitate automatic population and continued synchronization of two or more databases, provide automatic execution of business rules to assign security privileges based on attributes of individuals as reflected by data in one database, and automatically assign access badges to individuals based on housing assignments of individuals as reflected by data from the one database.

### CROSS-REFERENCE TO RELATED APPLICATION

This application claims the benefit of U.S. Provisional application Ser. No. 60/590,455, filed Jul. 23, 2004, titled Security System Database Interface System and Method, the disclosure of which is expressly incorporated by reference herein.

### FIELD OF THE INVENTION

The present invention generally relates to a system and method for interfacing two or more databases, and more particularly to a database integration platform that facilitates data sharing and synchronization between an administration database and a security system database, and implements business rules to automatically perform certain security system tasks based on attributes of the data from the administration database.

### BACKGROUND OF THE INVENTION

Enterprises, such as universities and other large institutions, typically maintain multiple databases of information relating to individuals associated with the enterprise. For example, a university may maintain an administration system having a database of information that associates individuals with various aspects of campus life, including registrar functions, food services, housing, library services, photo badging, etc. The university may also use a security system having a database of information that governs access of individuals to access controlled areas such as dorm rooms, maintenance buildings, sports facilities, etc.

Typically, such administration systems and security systems function substantially independently. For example, the security database must be periodically updated to reflect changes in the administration database (e.g., newly enrolled or expelled students)—a time-consuming, expensive and error-prone process. Indeed, if a new security system is installed at an enterprise, administrative personnel generally are required to manually transfer essentially all of the information in the administration database to the security database, and manually assign the security rights to be associated with each individual in the database.

### SUMMARY OF THE INVENTION

The present invention provides a database integration platform configured to facilitate automatic population and continued synchronization of two or more databases. In one embodiment, the platform integrates a database of an administration system with a database of a security system. The platform may provide automatic execution of business rules to assign security privileges in the security system based on attributes of individuals as reflected by data from the administration database. Additionally, the platform may be configured to automatically assign access badges to individuals based on housing assignments of individuals as reflected by data from the administration database. In certain embodiments, the platform is further configured to facilitate data transfer from the security database to other components of the security system, and provide service and interaction reports that detail activities performed by the platform during operation.

The features and advantages of the present invention described above, as well as additional features and advantages, will be readily apparent to those skilled in the art upon reference to the following description and the accompanying drawings.

### BRIEF DESCRIPTION OF THE DRAWINGS

FIG. 1 conceptual diagram of a database integration platform according to the present invention coupled to an administration system and a security system.

FIG. 2 is a conceptual diagram of a security system.

FIG. 3 is a screen shot of an interface generated by a configuration utility of the platform of the present invention.

FIGS. 4-6 are screen shots of a flat file for importation from an administration database into the platform of the present invention.

FIG. 7 depicts the format of a data import table maintained in an interface database of the platform of the present invention.

FIG. 8 depicts the format of a data export table maintained in an interface database of the platform of the present invention.

FIG. 9 is a conceptual diagram of a process by which changes to a security database are synchronized in an administration database via the platform of the present invention.

FIG. 10 is a conceptual diagram of a process by which changes to an administration database are synchronized in a security database via the platform of the present invention.

FIG. 11 depicts a report generated by the platform of the present invention.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

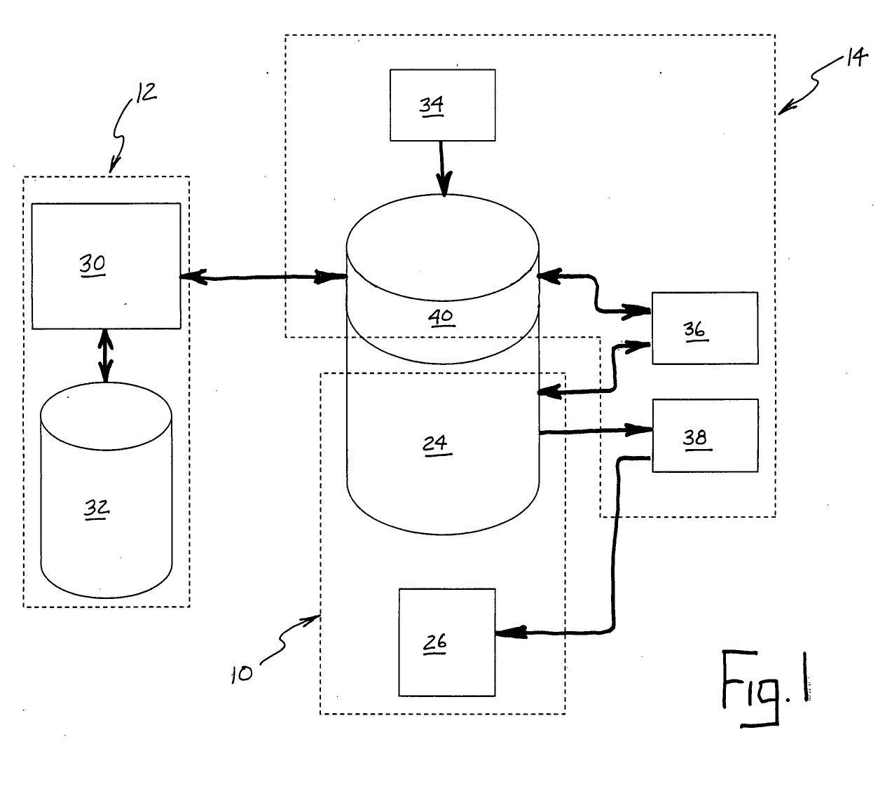

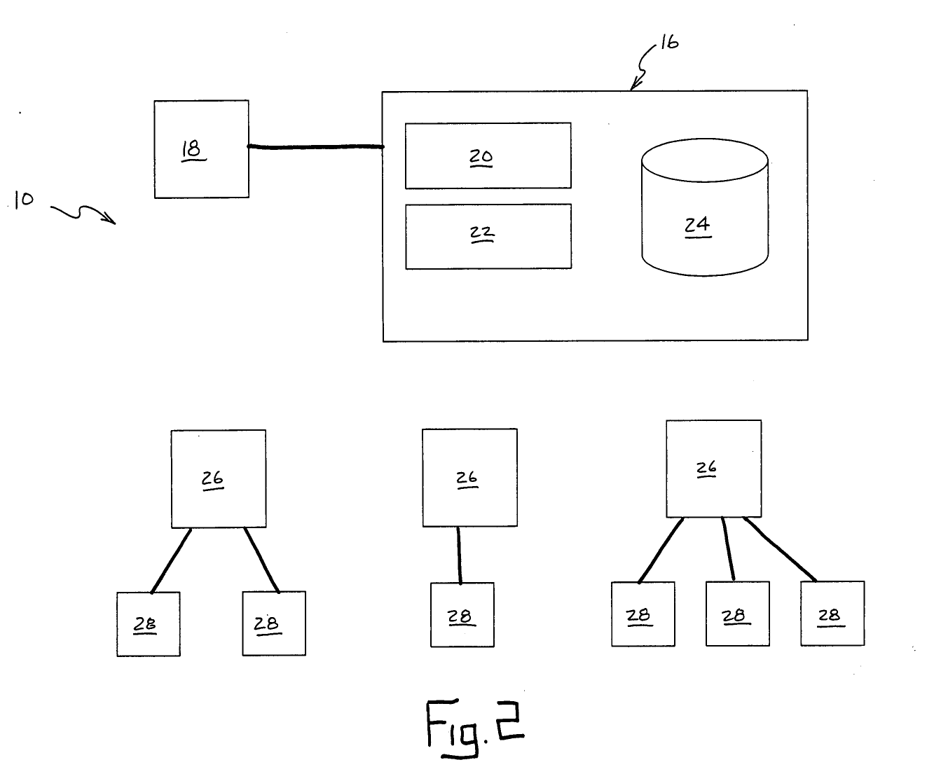

Referring now to FIG. 1, there is shown generally a security system 10, an administration system 12, and a database integration platform 14 according to one embodiment of the present invention. Security system 10 is an access control system such as the B.A.S.I.S.® System sold by Best Access Systems® of Indianapolis, Ind., a business unit of Stanley® Security Solutions. As shown in FIG. 2, security system 10 generally includes a server computing device 16, such as a workstation or personal computer, having a user interface 18, a display 20, software 22, and a security database 24 (also shown in FIG. 1), a plurality of access control panels 26 disposed at various locations throughout controlled areas of the facility, and one or more badge reader/door lock units 28 associated with each of panels 26. As is described in greater detail below, a user (e.g., a student) gains access to an area (e.g., a dorm room) by presenting his identification badge (not shown) to unit 28, which in turn verifies that the student associated with the badge has sufficient access rights (as reflected by data stored in security database 24) to enter the area, and electronically unlocks the door. An administrator of security system 10 uses computing device 16 to, among other things, assign access rights to users based on the requirements of the particular enterprise.

Referring back to FIG. 1, administration system 12 generally includes an administration computing device 30, such as a campus mainframe system or a plurality of networked subsystems, having, among other things, an administration database 32. Administration computing device 30 may be configured to operate any of a variety of different enterprise management programs such as Odyssey PCS™ which is sold by the CBORD® Group, Inc., headquartered in Ithaca, N.Y., or the Blackboard Transaction System™ which is sold by Blackboard, Inc., headquartered in Washington, D.C. In general, such software systems provide an enterprise the ability to configure, control, and monitor various activities of individuals associated with the enterprise. On a university campus, for example, these systems may permit management of functions such as on-campus or off-campus point-of-sale transactions, registrar functions, meal card usage, housing assignments, photo badging, library services, etc. Administration system 12 permits management of such functions by maintaining information in administration database 32 specific to each of the provided functions as they are to be implemented or controlled with respect to individuals. Accordingly, administration database 32 includes one or more data records (as is further described below) associated with each user of administration system 12, which uniquely identify the individual users and provide descriptive entries relating to characteristics and/or attributes of the individuals (collectively referred to as “demographic data”). The demographic data in administration database 32 is typically configured for access as text files or using Open DataBase Connectivity (“ODBC”), a well-known standard database access method developed by the SQL Access group in the early 1990s.

Platform 14 of FIG. 1 generally includes a configuration utility 34, an interface service 36, a download script 38, and an interface database 40. Configuration utility 34 generally enables set up functions and feature configuration for platform 14 as is further described below. In one embodiment, interface service 36 is a Microsoft® Windows® service that runs in the background during operation of platform 14 and periodically processes changes to interface database 40 or security database 24 as is further described below. Download script 38 generates data exchange scripts that reflect changes initiated by platform 14 and are used to update panels 26 as is further described below. Interface database 40 includes data import and export tables which are added to or obtained from security database 24. These tables provide interim data handling for information exchanged between administration database 32 and security database 24 as is further described below.

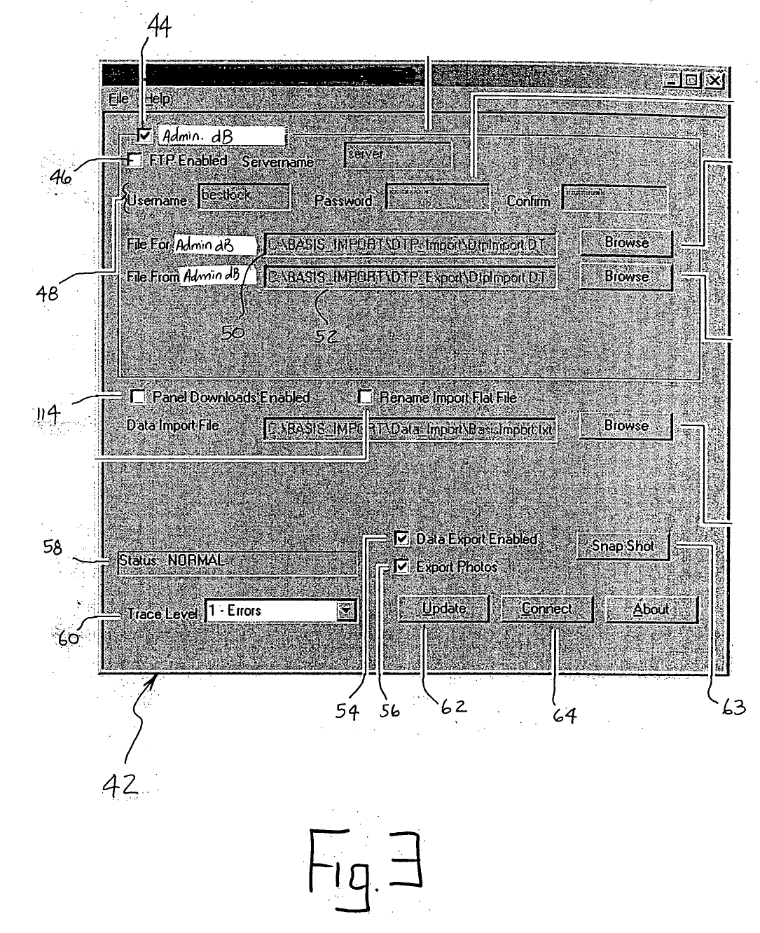

Platform 14 may be installed on computing device 16 or elsewhere, and can be used with Microsoft® SQL 2000 Server databases, Oracle® 9i databases, or any other database having suitable characteristics. After installation, the user is prompted to activate configuration utility 34. FIG. 3 depicts an interface 42 generated by configuration utility 34 upon activation. The following discussion of interface 42 assumes platform 14 is being configured to interface with an administration database 32 as associated with the enterprise management program Odyssey PCS™ sold by the CBORD® Group, Inc. It should be understood, however, that the principles embodied in platform 14 may be applied in applications including any other appropriate administration database 32. Interface 42 includes a checkbox 44 for enabling processing of data from administration database 32, a checkbox 46 for enabling FTP transfer of data from administration database 32 that are not located on computing device 30, user login fields 48, an import file location field 50 that specifies the pathname of data files to be imported from administration database 32, an export file location field 52 that specifies the pathname of data files to be exported to administration database 32, a checkbox 54 to enable export of data from security database 24, a checkbox 56 to enable export of photos from security database 24, a status field 58 that indicates the current status of interface database 40, a trace level selection field 60 with associated drop down button to permit selection of the level of detail to be recorded in an error log (discussed below), an update button 62 that saves configuration changes, a snapshot button 63 to execute a snapshot export function as described below, and a connect button 64 that connects platform 14 to administration system 12 and verifies the integrity of the import and export tables of interface database 40.

During installation, platform 14 creates the data import table and the data export table of interface database 40 as mentioned above. The data import table may be populated using database administrative transfer tools, tools provided by security system 10, database specific transfer tools such as DTS, and custom scripts. When the demographic data is transferred from administrative database 32 to the data import table, interface service 36 detects the presence of the data and updates security database 24 as is described in greater detail below. The data export table permits exportation of security information stored in security database 24 to administrative database 32. More specifically, when changes are made to data stored in security database 24 such as badge or account status, or the issuance of a new badge, interface service 36 detects the changes and adds the changed data to the data export table of interface database 40. Administration system 12 may be configured to mine the data residing in data export table using any of the transfer methods mentioned above. It should be understood that the user of the administration system 12 may be required to manually delete the data in the data export table after transferring that data to administration system 12. Alternatively, this process may readily be automated using techniques that are well-known to those skilled in the art.

Four types of data may be imported into security system 10 using platform 14 including control data, demographic data, badge data, and access level data. Control data generally indicates which individual is affected by an action, what the action is, and how the individual is to be mapped into security database 24. Demographic data generally includes detailed information about the individual, such as name, address, phone number, title, birth date, department, social security number, location, email address, photographic image, etc. Badge data includes information relating to any or all of multiple badges that may be issued to the individual. In one embodiment of the invention, three different badges may be assigned to the individual, including a meal badge, a guest badge, and a standard badge. Finally, access level data includes information describing the individual's ability to enter areas controlled by security system 10.

In addition to the data import table and data export table, interface database 40 includes a master lookup table that associates an individual having a badge used by security system 10 with the same individual in administration database 32 as is further described below. Each individual in security database 24 has a unique identifier record in the master lookup table. Corresponding individuals in administration database 32 are associated with a customer number. One or both of the unique identifier record in the master lookup table and the customer number are used to identify each record to be imported or exported using platform 14 to indicate which data is being affected.

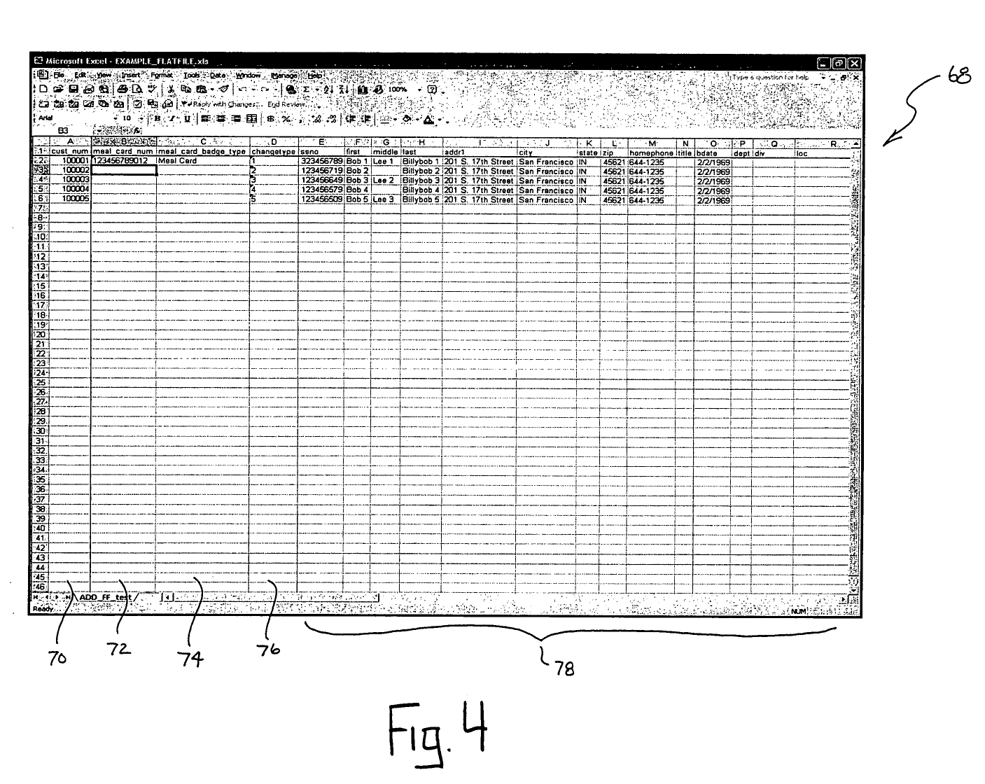

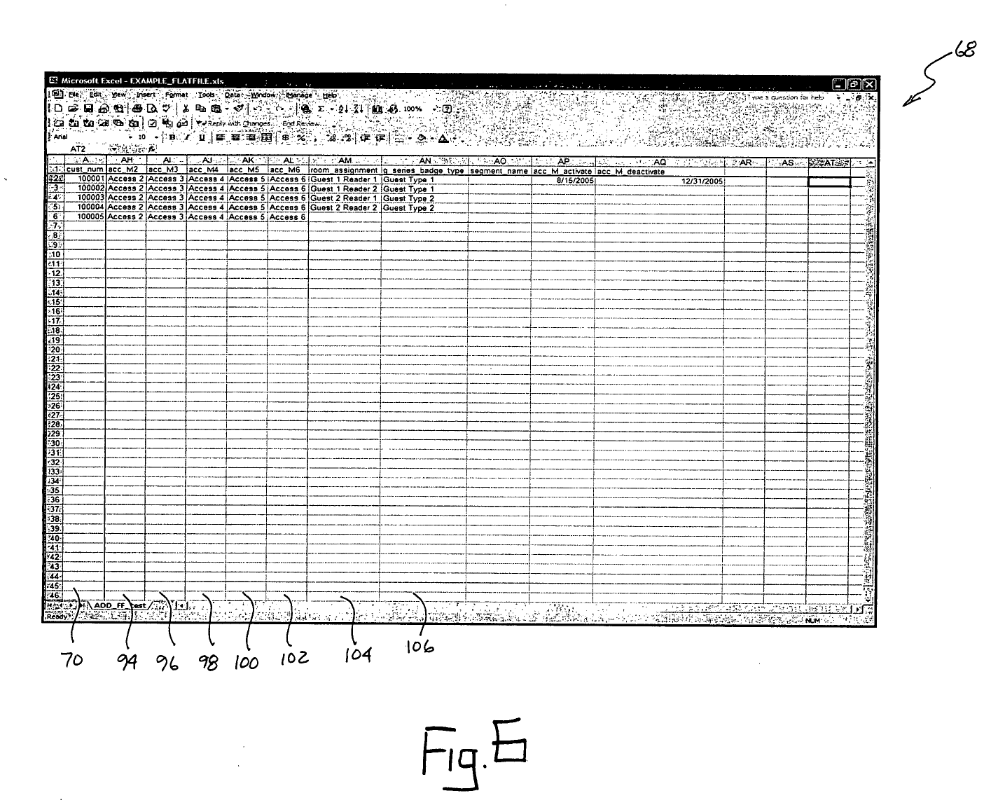

FIGS. 4-6 depict an example of a flat file 68 imported into platform 14, and illustrate sample control data. As shown, file 68 includes, among other things, a customer number column 70, a meal badge number column 72, a badge type column 74, a change type column 76, a plurality of columns 78 that include demographic data, a photo file column 79 that contains pathnames to image files, a badge ID column 81, a badge type column 83, an embossed number column 80, an activate column 82, a deactivate column 84, a status column 86, an issue code column 88, a PIN column 90, access level columns 92, 94, 96, 98, 100, 102, a room assignment column 104, and a guest badge type column 106. Data in change type column 76 indicates the action to be performed regarding the individual associated with the corresponding customer number. As indicated, the change type data may be any of a numeral 1 through 5. Each change type indicates to platform 14 a specific change to be made to data in security database 24. These changes are made automatically by platform 14, and can thus be considered a set of business rules that are applied generally to all applications of platform 14.

More specifically, when the change type data is a 1, interface service 36 is configured to access the master lookup table of interface database 40 to determine whether a unique identifier record exists that corresponds to the customer number associated with the change type data. If not, then interface service 36 creates a new, unique identifier record for that customer number and populates a data record associated with the new unique identifier record that includes the information relating to the individual and contained in file 68. If a corresponding unique identifier record exists, then interface service 36 compares the control data of the imported record to the control data in the interface database 40 associated with the corresponding unique identifier record, and changes the interface database 40 control data to match the imported data. This operation is a complete reconstruction of the data in interface database 40 relating to the individual reference in the imported record. Each item of control data (e.g., name, address, birthdate, access level, etc.) is compared to determine whether a difference exists between the existing date and the data in the imported record. Any difference causes an SQL Update of the appropriate tables in security database 24.

If the change type data is a 2, then interface service 36 deletes the data in interface database 40 associated with the badge type indicated by badge type column 74. If the change type number is a 3, then interface service 36 deletes the unique identifier record in interface database 40 corresponding to the customer number, including all badge data and access data. If the change type is a 4, then interface service 36 deletes the listed access levels in interface database 40 associated with the badge type indicated by the badge type column 74. More specifically, if an individual has four access levels active in security database 24 (e.g., level 1 through 4), and levels 1 and 2 are to be revoked, then the incoming data record will include a change type of 4 in column 76, the phrase “Access Level 1” in access level column 92, and the phrase “Access Level 2” in access level column 94. When presented with a data record having this content, interface service 36 is configured to revoke access levels 1 and 2 from interface database 40, which is later transferred to security database 24. Finally, if the change type is a 5, then interface service 36 deletes the all access levels in interface database 40 associated with the badge type indicated by the badge type column 74.

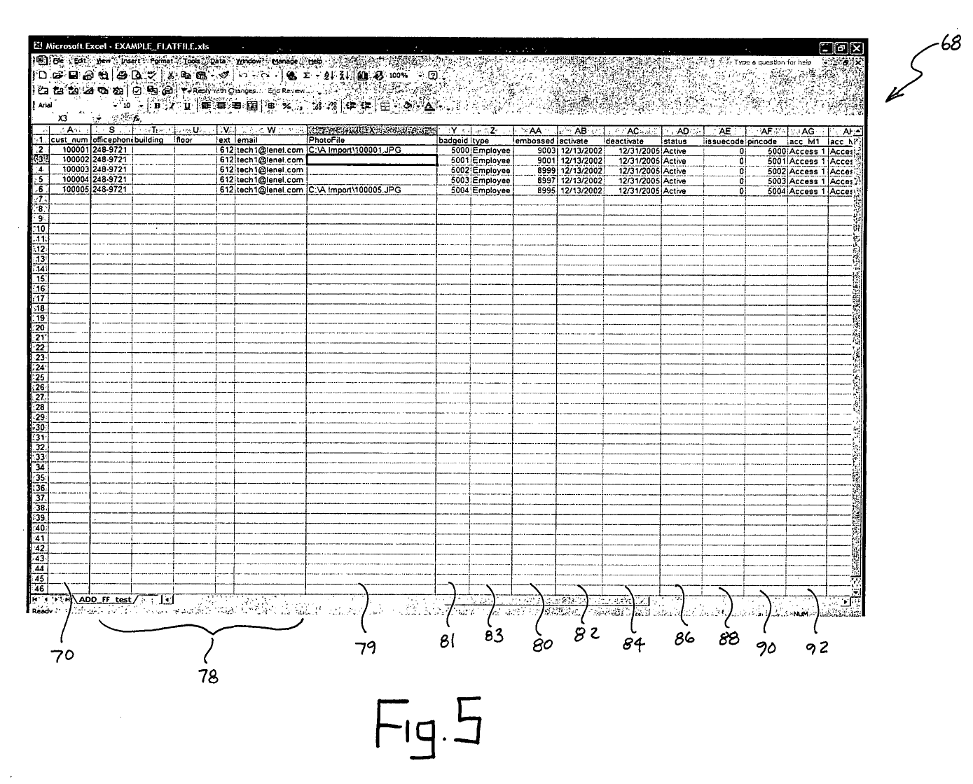

As indicated above, a single data record may affect three badges assigned to the corresponding individual. Each badge type is defined by its own data set. All badges are affected by global badge data included in an incoming data record. Global badge data includes data describing the activation and deactivation date (columns 82 and 84 of FIG. 5) of any badge(s) of the data record, a status field (column 86) that indicates whether the referenced badge is active, lost, or returned, a field (column 80) describing the number, if any, embossed on the surface of the referenced badge(s), and a PIN field (column 90) that specifies the personal identification number associated with either the referenced meal badge or the referenced standard badge. Any badge specified in the data record is updated with the appropriate global badge data when interface service 36 processes the data record.

A meal badge is specified by including a meal badge number in column 72 of file 68 and a meal badge type in column 74 of the incoming data record. The meal badge number is the number assigned to the meal badge by the administration system 12. Upon receipt of the meal badge number, interface service 36 determines whether a customer number or a unique identifier record exists in the master lookup table corresponding to the meal badge number. If the meal badge number is already associated with a different customer number or unique identifier record than that specified in the data record, then interface service 36 marks the old meal badge as lost and creates a new assignment. If the meal badge number is assigned to the individual referenced in the data record, then interface service 36 updates interface database 24 with the global badge data and access level data (columns 92-102) associated with the incoming data record. Meal badge type column 74 simply indicates to interface service 36 that the data record relates to a meal badge.

A data record may also indicate a room assignment for a guest badge of the individual referenced in the incoming data record. The data record indicates the room assignment in room assignment column 104 by specifying a reader 28 corresponding to the assigned room. Interface service 35 check interface database 24 to determine whether all guest badges available for association with the specified reader 28 have been assigned. If not, interface service 36 updates interface database 24 accordingly. Otherwise, an error is logged and the data record is not processed. The data record may also include in column 106 data to indicate the type of guest badge to be assigned to the specified room.

Finally, the data record may include standard badge data in badge ID column 81 of FIG. 5, an issue code field in column 88 of FIG. 5, and a badge type field in badge type column 83. The issue code relates to the number of times a badge has been issued. More specifically, each time a magnetic-stripe technology badge is issued, the last one or two digits of the complete number string on the badge are incremented. Badges are typically first issued with an issue code of 0. If the badge is lost or destroyed, a new badge may be printed for the individual. When the new badge is printed, the issue code is incremented to a 1. At that point, issue code 0 is invalid for that badge. If the old badge is presented to a reader 28, the issue code of 0 is detected and will cause the reader 28 to deny access.

The badge data in badge ID column 81 contains the unique identification number associated with the badge in administrative system 12. The badge type field indicates that a standard badge is a subject of the data record. The badge type is essentially a template used to logically flag behavior and graphical design layout of the badge. For example, a “Staffbadgep” type may be defined, and include a blue background, allowing facility personnel to easily determine the legitimacy of the wearer's presence in a secure area. Automatic access level privileges may be assigned to a badge type as well. Finally, a badge type also informs software 22 of security system 10 that the numbers on the badge are to be interpreted in a unique manner via card formats. A card format can dictate, for example, that the first seven digits on a magnetic stripe badge are unique to the facility, the next nine digits are the account number, and the final two digits are the issue code.

As indicated above, access level data relates to the individual's ability to enter areas controlled by security system 10. In one embodiment of the invention, any of up to six access levels may be assigned to a specified badge at a time. In general, each access level refers to a different combination of time and place restrictions to the individual's access rights. Platform 14 processes various identifiers (name, department, location, etc.) used in administration database 32 to automatically assign a predefined set of access rights associated with one of the six access levels. For example, a data record from a flat file of administration database 32 may include an entry describing the function of the individual as “Accounting” as shown in cell 108 of FIG. 5. Platform 14 may be configured to automatically associate any individual having a functional description of “Accounting” with a particular access level. Accordingly, when interface service 36 identifies the functional description “maintenance,” it indicates to security system 10 that access level 1, for example, should be associated in security database 24 with the referenced individual. Security system 10 may be configured to permit all individuals with access level 1 to pass through all doors associated with all readers 28 during the hours between 5:00 a.m. and 11:00 p.m. Other functional identifiers, such as “maintenance” or “mail room” may be associated by platform 14 with other predefined access levels of security system 10. In this manner, classification data (e.g., functional description, title, pay grade, etc.) already present in administrative database 32 is used by platform 14 to automatically assign access rights for use by security system 10, thereby eliminating the need for an administrator to individually select access rights for each person reflected in administration database 32. Again, the relationship between the classification data of administration database 32 and the access levels of security system 10 is an example of a set of business rules implemented by platform 14. Accordingly, if an incoming data record includes in change type column 76 a change type data 1 (add or modify record, as described above), then interface service 36 either creates a new record or modifies an existing record to reflect an access level corresponding to the classification data contained in the incoming data record.

Alternatively, if an incoming data record includes in change type column 76 a change type data 4 (delete access levels as described above), then interface service 36 deletes all access levels associated with the individual identified in the incoming data record. It should be understood that before automatically assigning access rights, platform 14 may be configured to verify that the current date falls between the activation and deactivation dates included in columns 82 and 84, respectively, of file 68.

As indicated above, in addition to the import table, interface database 40 includes an export table for moving data from security database 24 to administration database 32. The export table generally employs a format that mirrors that of the import table as described above. In one embodiment of the invention, two methods of exporting data from security database 24 are provided. Specifically, platform 14 supports a snapshot export and an incremental export as described below. A snapshot export assures baseline synchronization between security database 24 and administration database 32. When executed, the snapshot export function causes interface service 36 to first delete the entire existing content of the export table of interface database 40. After the export table is cleared, interface service 36 accesses the master lookup table in interface database 40 and, for each individual having a unique identifier record, creates a set of export records that contain all of the exportable control data, demographic data, badge data, and access level data associated with that individual. The export table is then populated with these sets of data. The snapshot export function is well suited for initial synchronization between security database 24 and administration database 32, and is executed by activating configuration utility 34 and clicking on snapshot button 63 as shown in FIG. 3.

The incremental export function provided by platform 14 populates the export table with data reflecting changes (additions, deletions, and modifications) to security database 24 as they occur during operation of security system 10. The incremental export function may be set up to automatically execute in response to changes to security database 24 by activating configuration utility 34, selecting data export checkbox 54 (and photo export checkbox 56, if appropriate), and clicking update button 62 as depicted in FIG. 3.

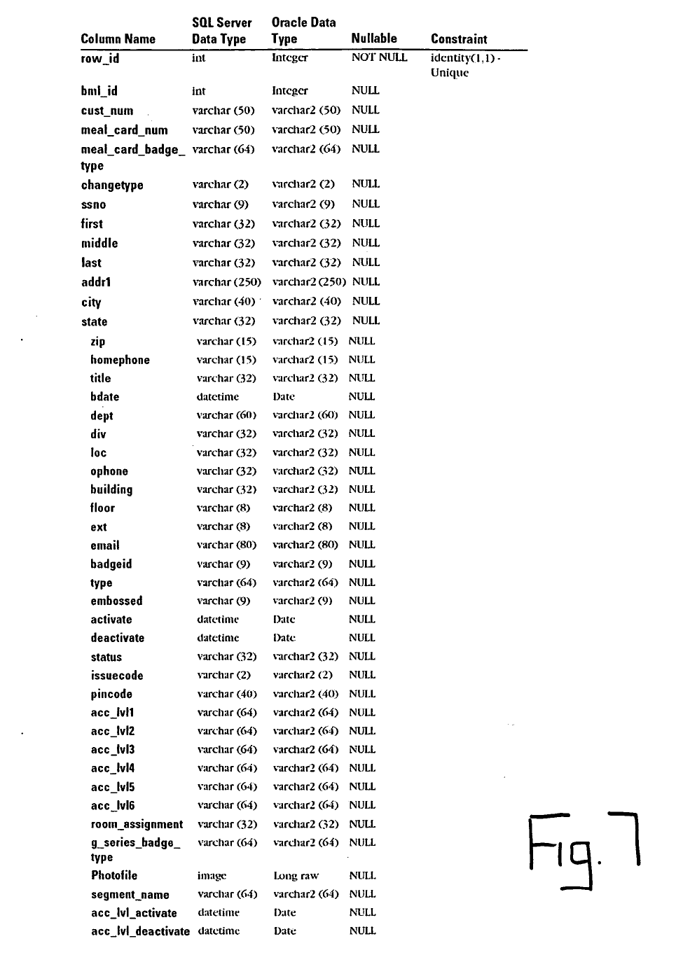

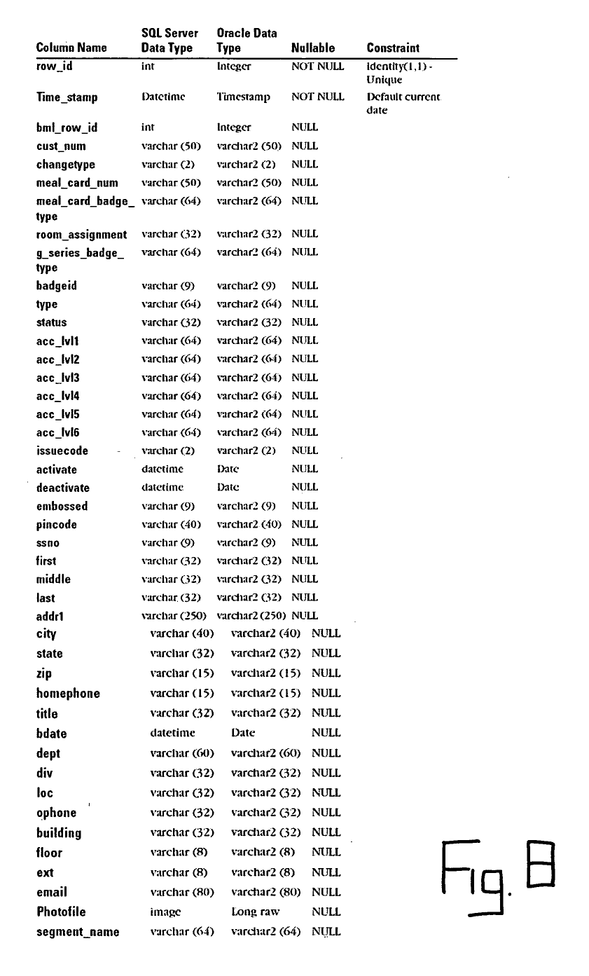

A sample of the structure of the data import table stored in interface database 40 is depicted in FIG. 7. As shown, a variety of different variables are identified by column name and defined by variable type, depending upon whether platform 14 is interfacing with an SQL server or Oracle. FIG. 8 similarly depicts a sample of the structure of the date export table stored in interface database 40.

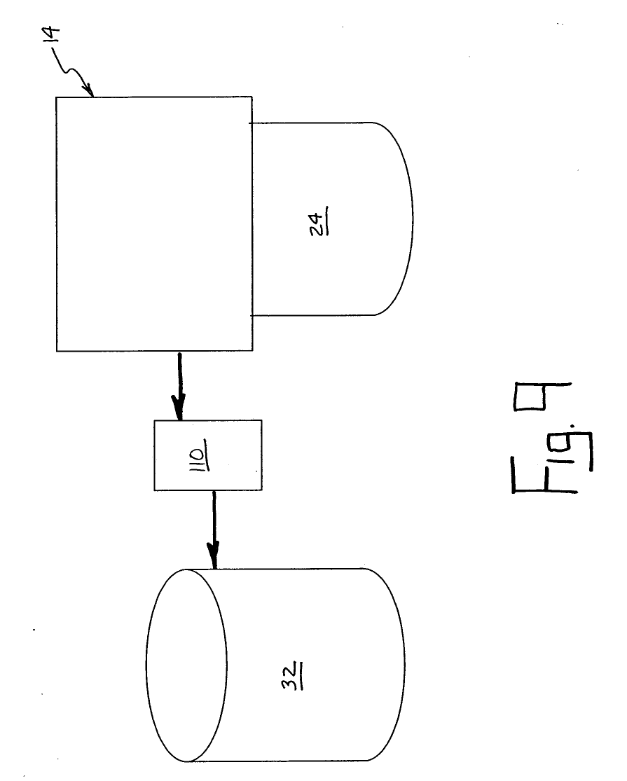

FIG. 9 depicts a process by which administration database 32 and security database 24 automatically remain synchronized when changes occur in security database 24. When a change is made to security database 24 by a database administrator, interface service 36 of platform 14 detects the change and creates a direct transaction processing (DTP) file 110 for administration system 12. Platform 14 places file 110 in the location specified in export file location field 50 of FIG. 3 during set up using configuration utility 34. Administration system 12 is configured to periodically access the designated location and import any file 110 for processing. As should be understood from the foregoing, administration system 12 is also configured to extract the content of file 110, and update administration database 32 accordingly.

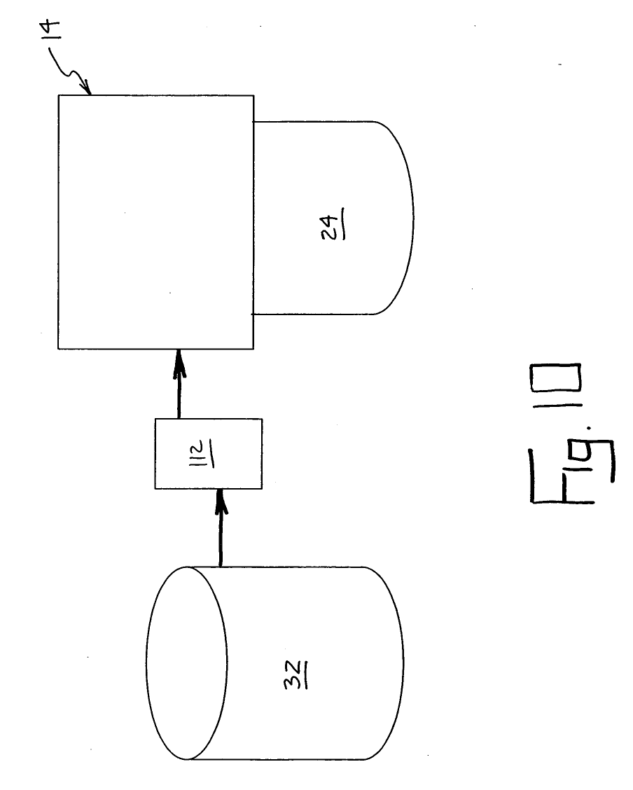

FIG. 10 similarly depicts a process by which database synchronization is accomplished when changes are made to administration database 32 by a database administrator. When a change is made to administration database 32, administration system 12 detects the change and creates a direct transaction processing (DTP) file 112 for platform 14. Platform 14 detects the existence of file 112 based on its name and location (previously designated in import file location field 52 of FIG. 3 during set up using configuration utility 34, imports file 112, processes its contents, and updates security database 24 accordingly. Platform 14 also creates and stores a backup of file 112, then deletes file 112 to permit creation of subsequent files reflecting changes to administration database 32.

As indicated above, platform 14 also includes download scrip 38 to facilitate automatic downloading of information to panels 28 of security system 10. In one embodiment of the invention, updates to security database 24 via the above-described synchronization methods are not automatically transferred to panels 28. Instead, the updates are transferred to a personal digital assistant or similar device (not shown), which is manually transported to each of panels 28 and configured to communicate with panels 26 for data transfer. It should be understood, however, that in other embodiments according to the principles described herein, security system 10 may be configured such that updates to security database 24 are automatically transmitted (by wired connection or wirelessly) to each of panels 28.

Again referring to interface 42 (FIG. 3) of configuration utility 34, download script 38 is configured by selecting panel downloads enabled checkbox 114. Interface service 36 interprets selection of panel downloads enable checkbox 114 as an instruction to save panel download information in a table in interface database 40 as badge data is changed using platform 14 as described herein. As badges are affected by platform 14 within security database 24, the need to reflect these changes in the field hardware panels 26 and readers 28 exists. When a badge is affected, its primary key value is entered into an SQL table of security database 24 along with a time stamp of the transaction. When software 22 of security system 10 runs on its scheduled configuration, it reads from the SQL table and updates a badge table in security database 24, marking a badge last changed field with the time stamp stored in the SQL table. This update is causes software 22 to update panels 26 and readers 28 with the most current data for that badge.

Next, the user opens a predefined form such as a form generated using FormsDesigner™ software. When the form is selected, the user should elect to define the variables so that the data in the script executed by download script 38 is downloaded properly to panels 28. In doing so, the user defines the source of the data to be downloaded to panels 28 as security system 10. Platform 14 is configured such that selection of security system 10 as the source of the data causes platform 14 to configure the script for panel download to accept data from security system 10 according to a predefined format and download the data to panels 28 according to a predefined format. The format for panel download is a proprietary manufacturer COM language piece. The format for the data to be read is matched to the SQL table. As the user points to the SQL table from within FormsDesigner™ configuration screen, each field in the source table is matched with a field in the target table.

Next, the user opens a system administration application provided by security system 10 and selects a scheduler function. The scheduler function provides a plurality of actions that may be added to the operation of security system 10, including a panel download script, which is selected by the user. Additionally, the user is permitted to define the frequency at which the panel download script will be run during operation of platform 14.

As indicated above, platform 14 also provides a reporting function. Before the reporting function is executed, the user should set a trace level using trace level selection field 60 as shown in FIG. 3. In one embodiment of the invention, two standard reports are provided by platform 14—an interface service report and an interaction report. The report templates may be created using a reporting application integrated with security system 10 such as Crystal Reports® which is sold by Business Objects™, a software company with U.S. headquarters in San Jose, Calif. The interface service report is a detailed log of actions taken by interface service 36 during operation of platform 14. Depending upon the trace level set by the user, the interface service report includes entries of errors relating to data records that were not processed correctly by interface service 36 or problems in the set up of interface service 36. Higher trace levels provide increased detail in the interface service report. The interaction report is a detailed log of interactions between security system 10 and administration system 14, including an identification of the system (i.e., one of security system 10, administration system 14, and platform 14) that initiated the interaction. Again, the level of detail of the interaction report depends on the trace level set by the user. As should be apparent from the foregoing, security system 10 may provide as part of the system administration application the ability to select one of the at least two predefined reports for viewing or printing.

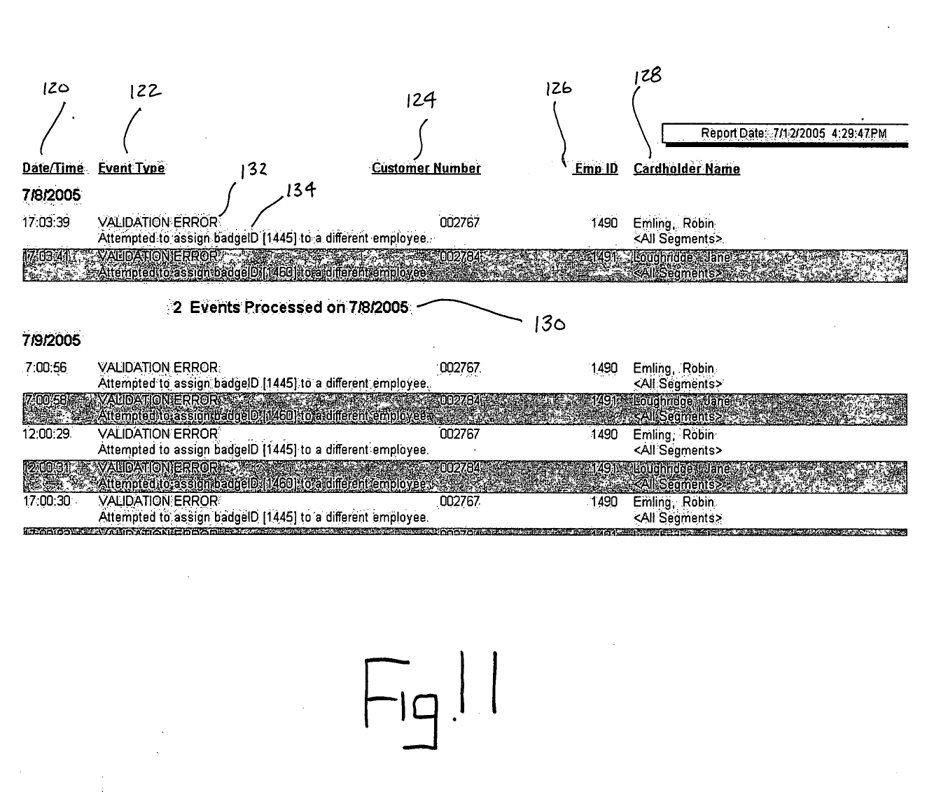

A sample of an interface service report is depicted in FIG. 11. As shown, the report may include a date/time column 120, an event type column 122, a customer number column 124, an employee ID column 126, and a cardholder name column 128. Processing errors may be grouped by day, and separated by a message 130 indicating the total number of errors for the day. Event type column 122 may include an error name 132 and an error explanation 134. Customer number column 124 includes the customer number associated in administration database 32 with the individual that is the subject of the data record. Employee column 126 includes an internal identifier issued to the individual referenced in the data record. Finally, cardholder name column 128 includes the name of the individual associated with the customer number in customer number column 124.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A platform for integrating an administration database and a security database, including:
an interface database including a data import table and a data export table; and
an interface service configured to automatically respond to a transfer of data from the administration database to the data import table by updating the security database, and to automatically respond to changes to data in the security database by populating the data export table with the changed data for transfer to the administration database, the interface service thereby maintaining synchronization between the administration database and the security database.

2. The platform of claim 1 further including a configuration utility for generating a user interface configured to permit a user to define a location of the administration database and a location of the security database.

3. The platform of claim 1 wherein the data import table and the data export table are configured to store control data, demographic data, badge data, and access level data.

4. The platform of claim 1 wherein the security database is part of a security system for controlling access to areas of a facility, the security system including a plurality of panels positioned throughout the facility and at least one reader coupled to each panel, the readers being configured to read data from badges, transfer the read data to a panel, and control access to an area based on instructions from the panel which compares the badge data to access data stored in the panel.

5. The platform of claim 4 wherein the access data stored in the panels is obtained from the security database.

6. The platform of claim 4 wherein the interface database further includes a master lookup table that relates an individual having a badge used by the security system with data in the administration database corresponding to the individual.

7. The platform of claim 1 wherein data is transferred from the administration database to the import table in the form of a plurality of data records, each data record including a change type number that indicates how the interface service should update the security database.

8. The platform of claim 7 wherein each data record includes an identifier of an individual to which the data in the data record relates.

9. The platform of claim 8 wherein the interface service responds to a first change type number by creating a new record for the individual in the interface database if a record for the individual does not exist, and by comparing the data in the data record having the first change type number with data associated with the individual in the interface database and changing the interface database data to match the data record data.

10. The platform of claim 9 wherein the interface service responds to a second change type number by deleting data in the interface database associated with a badge of the individual.

11. The platform of claim 10 wherein the interface service responds to a third change type number by deleting all data in the interface database associated with the individual.

12. The platform of claim 11 wherein the interface service responds to a fourth change type number by deleting access data in the interface database as specified in the data record.

13. The platform of claim 7 wherein each data record is configured to include data relating to any of a plurality of different badge types.

14. The platform of claim 13 wherein the plurality of different badge types includes a meal badge type, a guest badge type, and a standard badge type.

15. The platform of claim 7 wherein each data record is configured to include data relating to a room assignment of an individual having a guest badge.

16. The platform of claim 7 wherein each data record is configured to include classification data relating to a characteristic of an individual, the interface service being configured to automatically assign an access level to the individual based on the classification data and the change type number.

17. The platform of claim 2 wherein the user interface permits the user to execute a snapshot export that causes the interface service to delete the content of the export table, and create a set of export records to populate the export table, the set of export records containing data relating to all individuals having data records in the interface database.

18. The platform of claim 2 wherein the user interface permits the user to set up an incremental export function that causes the interface service to populate the export table with data reflecting changes to the security database as the changes are made.

19. The platform of claim 1 further including a download script that, when enabled, cause the interface service to save changes to interface database in a download table, the download table being compatible with an access control panel associated with the security database.

20. The platform of claim 1 further including a reporting function configured to provide a plurality of reports containing information relating to operation of the platform.

21. The platform of claim 20 further including a configuration utility for permitting a user to select a level of detail to be contained in a report.

22. A method of synchronizing data between two databases, including the steps of:
providing a first database containing administration data;
providing a second database containing security data;
providing a platform for receiving administration data from the first database and automatically mapping the administration data to the second database, and receiving security data from the second database and automatically mapping the security data to the first database.

23. The method of claim 22 further including the step of automatically changing the security data based on a change type number contained in the administration data.

24. The method of claim 22 further including the step of automatically assigning as access level to an individual based on classification data included in the administration data.

25. A method for synchronizing an administration database and a security database, including the steps of:
detecting a change to data in the administration database;
importing the changed data from the administration database to a platform coupled to the administration database and the security database;
determining the type of change from data included in the changed data from the administration database;
updating the security database with the changed data from the administration database according to the type of change;
detecting a change to data in the security database;
exporting the changed data from the security database to the platform; and
updating the administration database with the changed data from the security database.
